(19) United States
(12) Patent Application Publication
(10) Pub. No.: US 2026/0155060 A1
(43) Pub. Date: Jun. 4, 2026

(54) SYSTEM AND METHOD FOR IMPLEMENTING INTERACTIVE LANGUAGE LEARNING

(71) Applicant: METAL INDUSTRIES RESEARCH AND DEVELOPMENT CENTRE, Kaohsiung (TW)

(72) Inventors: Pei-Rong ZENG, Kaohsiung (TW); Bo-Hong ZHENG, Kaohsiung (TW); Tzu-Yu CHEN, Kaohsiung (TW); Bo-Wei PAN, Kaohsiung (TW)

(21) Appl. No.: 18/967,286

(22) Filed: Dec. 3, 2024

(51) Int. Cl. G09B 19/04; G06F 3/0482; G09B 5/06; G10L 15/22

(52) U.S. Cl. CPC G09B 19/04; G06F 3/0482; G09B 5/06; G10L 15/22

(57) ABSTRACT

A system for implementing interactive language learning includes a microphone, an audio output unit, a data storage unit, a display unit, and a controller. The controller generates an audio signal related to a question stored in the data storage unit, and controls the audio output unit to output the audio signal. In response to receipt of a speech signal, the controller outputs a text answer based on the speech signal. The controller determines whether the text answer corresponds with one of a plurality of predetermined answers associated with the question, generates one of an affirmative response and a guidance response based on the determination, transforms the one of the affirmative response and the guidance response into a form of speech, and controls the audio output unit to output the one of the affirmative response and the guidance response as a new audio signal.

### FIELD

The disclosure relates to a system and a method for implementing interactive language learning.

### BACKGROUND

According to the definition provided by the National Institute of Mental Health (NIMH), autism spectrum disorder (ASD) is a neurological and developmental disorder that affects the patient's ability to interact with other people, communicate, learn and behave. Children with ASD may have symptoms such as slow language development, unable to properly structure sentences, and unable to orally communicate, etc.

Current speech therapy programs involve therapists conducting at least one session (for example, a 30-minute long session) with a patient per week, and the patient performing language learning practicing (typically with family members) for at least three hours per week. A typical speech therapy program may span months to years to take effect. It is noted that due to various issues, the availability of the family members to continuously help with language learning and practicing may be limited. Moreover, since the family members may not be professional personnel, the language learning and practicing may not be done in an efficient manner and may potentially induce negative emotions for the family members and therefore the patient.

### SUMMARY

Therefore, an object of the disclosure is to provide a system that can alleviate at least one of the drawbacks of the prior art.

According to one embodiment of the disclosure, a system for implementing interactive language learning includes a microphone, an audio output unit, a data storage unit, a display unit, and a controller.

The microphone is for receiving a speech input from a user, and outputs a speech signal. The audio output unit is for receiving an audio signal and outputting the same. The data storage unit stores a language database, a plurality of learning screens, and a plurality of predetermined answers. Each of the plurality of learning screens includes a question area that displays a question that is associated with one of the plurality of predetermined answers, a display unit that is for, in response to receipt of a display signal, displaying one of the plurality of learning screens. The controller is connected to the microphone, the audio output unit, the data storage unit and the display unit. The controller includes a speech recognition module, a text generation module and a speech synthesizing module.

The speech synthesizing module is programmed to process the question to generate the audio signal related to the question. The speech recognition module is programmed to process the speech signal for recognizing a speech, and to output a text answer based on the speech signal. The controller is programmed to determine whether the text answer corresponds with one of the plurality of predetermined answers associated with the question, generate one of an affirmative response and a guidance response based on a result of the determination, control the speech synthesizing module to transform the one of the affirmative response and the guidance response into a form of speech, and controls the audio output unit to output the one of the affirmative response and the guidance response as a new audio signal.

Another object of the disclosure is to provide a method for implementing interactive language learning.

According to one embodiment of the disclosure, the method is for implementing interactive language learning, the method being implemented using a above mentioned system. The method includes:
A) controlling, by the controller, the display unit to display one of the plurality of learning screens;
B) controlling, by the controller, the audio output unit to output a speak signal that is associated with the content of the question area included in the one of the plurality of learning screens, and receiving, by the microphone, the speech signal;
C) converting, by the controller, the speech signal into a text answer and comparing the text answer to the one of the plurality of predetermined answers so as to determine whether the text answer corresponds with the one of the plurality of predetermined answers; and
D) in the case that the determination of step C) is negative, generating a guidance response, controlling the speech synthesizing module to transform the guidance response into a form of speech, and controls the audio output unit to output the guidance response as a new audio signal.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating a system for implementing interactive language learning according to one embodiment of the disclosure.

FIG. 2 illustrates an exemplary first learning screen associated with the echolalia mode.

FIG. 3 illustrates an exemplary second learning screen associated with the graphic card mode.

FIG. 4 illustrates an exemplary third learning screen associated with the picture book mode.

FIG. 5 illustrates an exemplary fourth learning screen associated with the dialog mode.

FIG. 6 is a flow chart illustrating steps of a method for implementing interactive language learning according to one embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

Throughout the disclosure, the term “coupled to” or “connected to” may refer to a direct connection among a plurality of electrical apparatus/devices/equipment via an electrically conductive material (e.g., an electrical wire), or an indirect connection between two electrical apparatus/devices/equipment via another one or more apparatus/devices/equipment, or wireless communication.

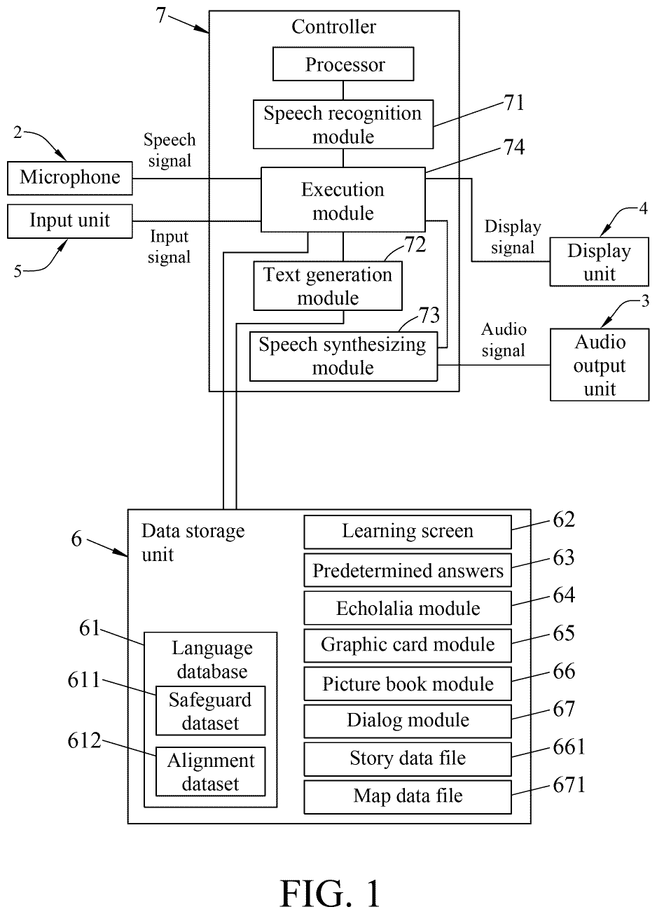

FIG. 1 is a block diagram illustrating a system for implementing interactive language learning according to one embodiment of the disclosure. In the embodiment of FIG. 1, the system may be embodied using a portable electronic device such as a smart phone, a tablet, a laptop, etc. The system includes a microphone 2, an audio output unit 3, a display unit 4, an input unit 5, a data storage unit 6, and a controller 7.

The microphone 2 may be a built-in component of the portable electronic device or an externally connected microphone. The audio output unit 3 may be embodied using a speaker built in the portable electronic device or an externally connected speaker. The display unit 4 may be embodied using a built-in display screen of the portable electronic device or an externally connected screen. The input unit 5 may be embodied using a keyboard/mouse, or other suitable input components. In some embodiments, the display unit 4 and the input unit 5 may be integrated into a touch screen.

The data storage unit 6 may be embodied using, for example, random access memory (RAM), read only memory (ROM), programmable ROM (PROM), firmware, flash memory, etc. In this embodiment, the data storage unit 6 stores a software application therein. The software application may be an interactive language learning software that can be downloaded and installed in the system and includes instructions that, when executed by a processor, cause the processor to implement the operations as described below.

The controller 7 is connected to the microphone 2, the audio output unit 3, the display unit 4, the input unit 5 and the data storage unit 6, and includes a processor 70 that may be embodied using a central processing unit (CPU), a microprocessor, a microcontroller, a single core processor, a multi-core processor, a dual-core mobile processor, a microprocessor, a microcontroller, a digital signal processor (DSP), a field-programmable gate array (FPGA), an application specific integrated circuit (ASIC), and/or a radio-frequency integrated circuit (RFIC), etc.

In use, the microphone 2 is for receiving speech input from a user, and outputs a speech signal from the speech input. The audio output unit 3 is for receiving an audio signal and outputting the same. The display unit 4 is for receiving a display signal and displaying the same. The input unit 5 is for receiving an input signal associated with a location of the display unit 4 (e.g., a mouse click, a tap on the touch screen, etc.).

The data storage unit 6 further stores a language learning application, which includes a language database 61, a plurality of learning screens 62, a plurality of predetermined answers 63, an echolalia module 64, a graphic card module 65, a picture book module 66, a story data file 661 associated with the picture book module 66, a dialog module 67, and a map data file 671 associated with the dialog module 67.

Each of the echolalia module 64, the graphic card module 65, the picture book module 66 and the dialog module 67 includes a software package and a number of objects associated with a respective operation mode for interactive language learning. In use, a user (e.g., a patient or a family member) may operate the system to select one of the operations modes provided. In the embodiment of FIG. 1, the operation modes include an echolalia mode, a graphic card mode, a picture book mode and a dialog mode.

In the embodiment of FIG. 1, the language database 61 includes a safeguard dataset 611 and an alignment dataset 612 that are used for assisting the generation of responses. The safeguard dataset 611 may include a plurality of inappropriate words and strings that are considered inappropriate (e.g., offensive, misleading, immoral, etc.), and a plurality of predetermined rules and content filters associated with content that is considered to be inappropriate for output by the audio output unit 3 or for display by the display unit 4. The alignment dataset 612 may include a number of predetermined words and strings that are typically used for providing various speech therapies (e.g., echolalia, demonstration, expansion, positive reinforcement, etc.), and may include content such as dialog for speech therapies, questions and answers for interacting with patients, and words for providing positive reinforcement with a soft tone, etc.

In use, the user may operate the input unit 5 of the system and execute the language learning application. In response, the controller 7 executes the language learning application and controls the display unit 4 to display a start screen that includes a number of buttons each associated with one of the operating modes.

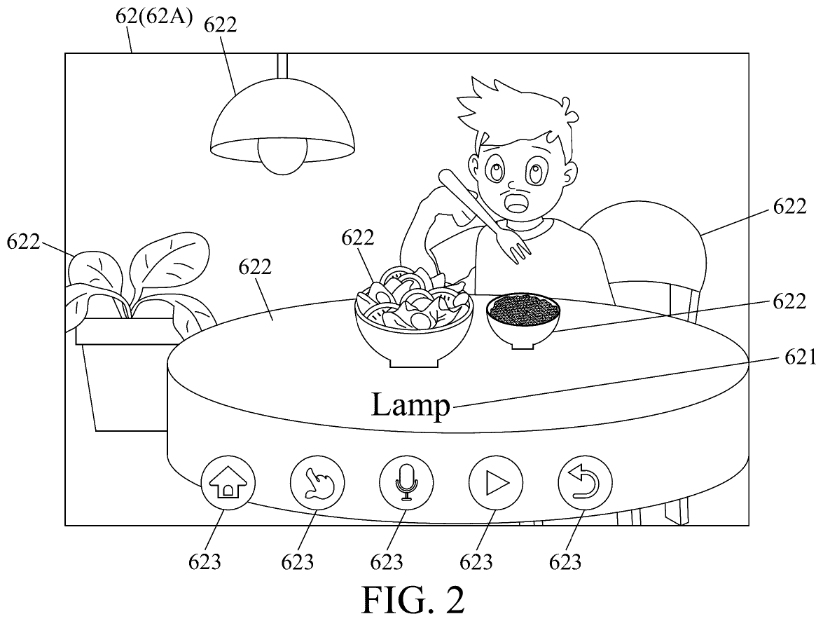

FIG. 2 illustrates an exemplary first learning screen 62A associated with the echolalia mode. In use, after the user selects the echolalia mode, the controller 7 may access the echolalia module 64 to generate the display signal, which causes the display unit 4 to, in response to receipt of the display signal, display the first learning screen 62A. The first learning screen 62A includes a question area 621, a plurality of selection areas 622 and a plurality of buttons 623.

The question area 621 may contain content related to a question, and is associated with one of the predetermined answers 63. In the embodiment of FIG. 2, the question area 621 includes the word “lamp”, indicating an instruction for the user to select an object in the first learning screen 62A that is a lamp. Each of the plurality of selection areas 622 may include an object that serves as one of options for the user to select as an answer to the question. In the embodiment of FIG. 2, one of the plurality of selection areas 622 includes a lamp (which is the one of the predetermined answers 63), and other selection areas 622 include various objects. The buttons 623 are shown in the bottom of the first learning screen 62A, and may be associated with different functions for the user such as “back to the menu”, “giving a hint”, “audio recognition”, “play the question related to the first learning screen 62A”, “back to a previous page”, etc.

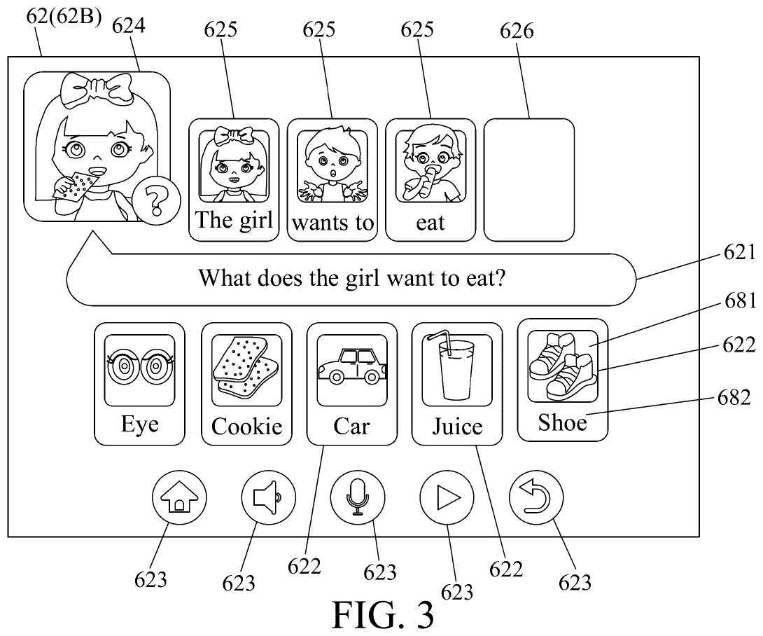

FIG. 3 illustrates an exemplary second learning screen 62B associated with the graphic card mode. In use, after the user selects the graphic card mode, the controller 7 may access the graphic card module 65 to generate the second learning screen 62B, and to control the display unit 4 to display the second learning screen 62B. The second learning screen 62B includes the question area 621, the plurality of selection areas 622, the plurality of buttons 623, a question image area 624, one or more graphic card objects 625, and an answering area 626. Each of the plurality of selection areas 622 includes a graphic area 681 and a text area 682. It is noted that in the embodiment of FIG. 3, five selection areas 622 and three graphic card objects 625 are present, but in other embodiments, different numbers of selection areas 622 and/or graphic card objects 625 may be provided.

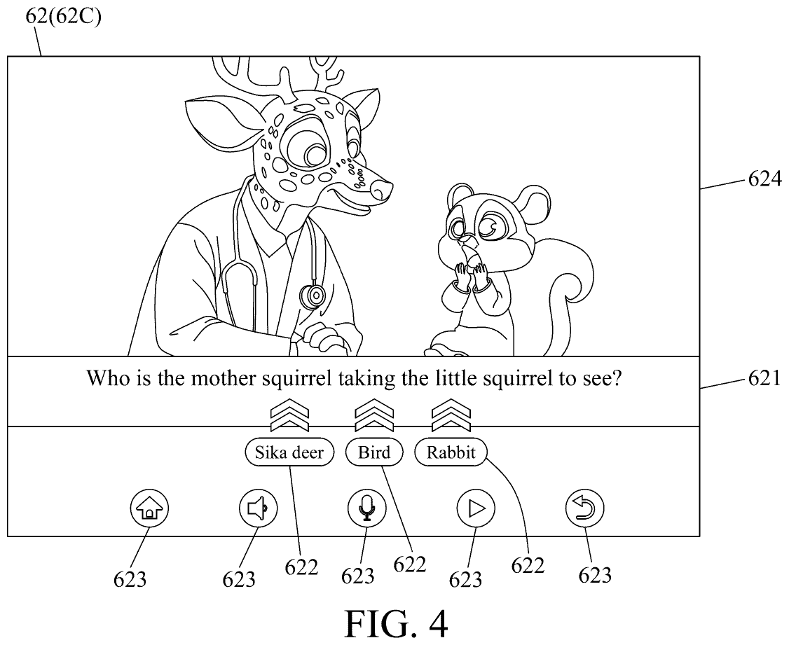

FIG. 4 illustrates an exemplary third learning screen 62C associated with the picture book mode. In use, after the user selects the picture book mode, the controller 7 may access the picture book module 66 to generate the third learning screen 62C, and to control the display unit 4 to display the third learning screen 62C. The third learning screen 62C includes the question area 621, the plurality of selection areas 622, the plurality of buttons 623, and the question image area 624.

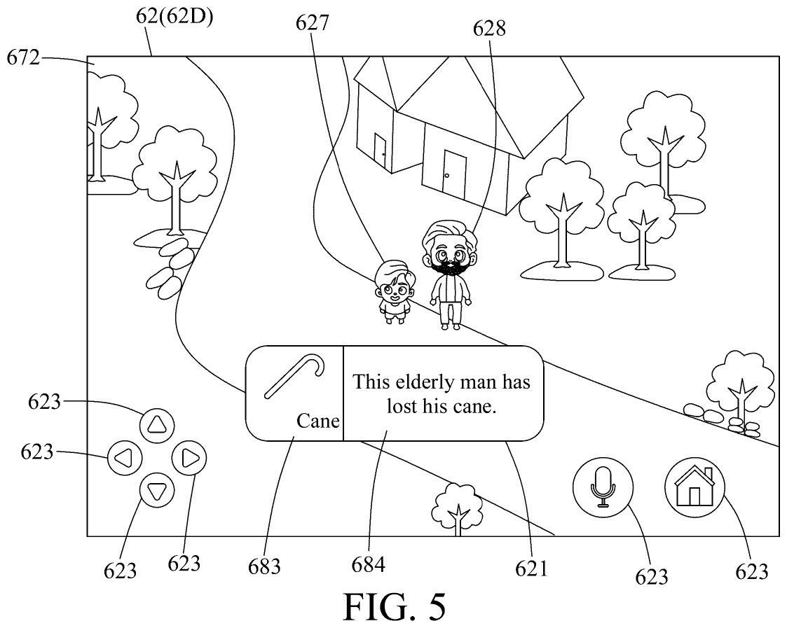

FIG. 5 illustrates an exemplary fourth learning screen 62D associated with the dialog mode. In use, after the user selects the dialog mode, the controller 7 may access the dialog module 67 to generate the fourth learning screen 62D, and to control the display unit 4 to display the fourth learning screen 62D. The fourth learning screen 62D may have a background taken from the content of the map data file 671 (e.g., a partial image extracted from a map 672 included in the map data file 671, indicating a geographical area), and includes the question area 621, the plurality of buttons 623, a player character area 627 that displays a player character associated with the user, and a non-player character (NPC) area 628 that displays an NPC that may interact with the player character. In the example of FIG. 5, the question area 621 may include an object portion 683 for displaying an object and a text portion 684 for displaying text dialog related to the question. The question is associated with one of the predetermined answers 63. Generally, the object displayed in the object portion 683 corresponds with the text dialog displayed in the text portion 684.

The controller 7 includes a speech recognition module 71, a text generation module 72, a speech synthesizing module 73, and an execution module 74. Each of the speech recognition module 71, the text generation module 72, the speech synthesizing module 73, and the execution module 74 may be linked to one another and embodied using software instructions that can be executed by the processor 70 for implementing the operations as described below. In some other embodiments, each of the speech recognition module 71, the text generation module 72, the speech synthesizing module 73, and the execution module 74 may be embodied using an existing software application or an online service.

The speech recognition module 71 is programmed to process a speech signal for recognizing the speech, and to output a text output of the speech. In embodiments, the speech recognition module 71 may be embodied using a software with speech-to-text (STT) functionality such as an application programming interface (API) for Whisper (a speech recognition model developed by OpenAI), a built-in application for certain operating systems, or an online service such as Google Speech-to-text, Amazon Transcribe, etc.

The text generation module 72 is for generating text based on an input. In use, the text generation module 72 may be embodied using a neural network trained using a language processing model such as Transformer, Bert, generative pre-trained transformer (GPT), etc. In training the text generation module 72, a professional dataset and a Mandarin language dataset may be employed. The professional dataset may include a number of predetermined words and strings that are typically used for providing various speech therapies (e.g., echolalia, demonstration, expansion, positive reinforcement, etc.), and may include content such as audio files and/or text files of dialog for speech therapies, questions and answers for interacting with patients, records of actual speech therapies, etc. The Mandarin language dataset may include content such as Mandarin texts and speech database. The Mandarin texts may include the content of Sinica Balanced Corpus of Modern Chinese provided by the Academia Sinica of Taiwan, and the content of Delta Reading Comprehension Dataset (DRCD). The speech database may include existing databases (e.g., MAT-400 and MATBN provided by The Association for Computational Linguistics and Chinese Language Processing, ACLCLP).

After being pre-trained using the professional dataset and the Mandarin language dataset, in use, in response to an input by the user, the text generation module 72 is configured to generate an output that is aimed to mimic a response from a professional speech therapist. In some embodiments, the input may be an answer to a question to the user, and in the case that the answer is incorrect, the response may be providing guidance and/or a hint instead of directly providing the correct answer. As such, the user may be able to discover and correct an issue. It is noted that the training of the text generation module 72 is well known in the related art, and details thereof are omitted herein for the sake of brevity.

In some embodiments, the system may be embodied using a portable electronic device and a server, and the data storage unit 6 storing the text generation module 72 and the language database 61 may be disposed in the server. As such, the portable electronic device may be connected to the server via a wireless communication and the data stored in the server may be accessed for implementing the operations as described below. In some embodiments, the portable electronic device may store a backup of the text generation module 72 and the language database 61 in order to implement the operations as described below in the condition that no wireless connection is available for the portable electronic device.

The speech synthesizing module 73 is configured to generate speech from a text input using commercially available text-to-speech (TTS) technique. In embodiments, the speech synthesizing module 73 may be implemented using an online service (e.g., Google Cloud TTS, Azure Speech, etc.) or a local application that can be accessed via an API (e.g., Variational Inference with adversarial learning for end-to-end Text-to-Speech (VITS), VALL-E, etc.) or a built-in application in different operating systems (e.g., iOS, Android, etc.).

In use, the content related to a question as shown in the question area 621 (e.g., the word “lamp” in FIG. 2) is processed by the speech synthesizing module 73, in order to generate speech of the content, which then serves as the audio signal.

The execution module 74 is configured to implement a number of operations. Specifically, the execution module 74 is connected to the microphone 2, the audio output unit 3, the speech recognition module 71, the text generation module 72 and the speech synthesizing module 73. The execution module 74 is configured to control the speech synthesizing module 73 to generate the audio signal and transmit the audio signal to the audio output unit 3 for outputting the audio signal. As such, in the case that the audio signal is generated from the content related to a question displayed in the question area 621, the system may be controlled to “read out” a question for the user.

Then, in different operation modes, the execution module 74 may be configured to implement different operations. For example, in the case of the echolalia mode as shown in FIG. 2, in response to the user speaking into the microphone 2, the speech signal is generated and transmitted to the execution module 74. The execution module 74 is then configured to control the speech recognition module 71 to transform the speech signal into a text, and to determine whether the text conforms with the one of the predetermined answers 63 associated with the question area 621. In the case where it is determined that the text conforms with the one of the predetermined answers 63 associated with the question area 621, the execution module 74 controls the text generation module 72 to generate an affirmative response in text form, which may be then transformed into speech by the speech synthesizing module 73 and outputted by the audio output unit 3 as the audio signal. Otherwise, in the case where it is determined that the text does not conform with the one of the predetermined answers 63 associated with the question area 621, the execution module 74 controls the text generation module 72 to generate a guiding response in text form, which may be then transformed into speech by the speech synthesizing module 73 and outputted by the audio output unit 3 as a new audio signal.

In some examples, the input from the user may be in the form of the input signal (e.g., for the example of FIG. 2, the user attempting to tap the lamp). In such cases, the execution module 74 determines whether the input signal conforms with the one of the predetermined answers 63 associated with the question area 621 (e.g., whether the user indeed taps on the lamp). In the case where it is determined that the input conforms with the one of the predetermined answers 63 associated with the question area 621, the execution module 74 controls the text generation module 72 to generate the affirmative response in text form, which may be then transformed into speech by the speech synthesizing module 73 and outputted by the audio output unit 3 as the audio signal. Otherwise, in the case where it is determined that the input signal does not conform with the one of the predetermined answers 63 associated with the question area 621, the execution module 74 controls the text generation module 72 to generate a guiding response in text form, which may be then transformed into speech by the speech synthesizing module 73 and outputted by the audio output unit 3 as the audio signal. It is noted that the generation of the affirmative response and the guiding response may be done with the use of the safeguard dataset 611 and the alignment dataset 612.

The operations of the system in respective operation modes (i.e., the echolalia mode, the graphic card mode, the picture book mode and the dialog mode) will now be described.

In the echolalia mode as shown in FIG. 2, the content of the echolalia module 64 is used for generating the first learning screen 62A. On the first learning screen 62A, each of the plurality of selection areas 622 may include an object (a lamp, a plant, a bowl of salad, a bowl of rice, a table, or a chair) that serves as one of the options for selection as an answer to the question. The question area 621 includes the text for instructing the user to identify a specific object by clicking on the object using a mouse or by tapping on the object. The question may be first generated and outputted in the form of speech (e.g., “please point out the lamp”).

It is noted that the predetermined answer 63 associated may be associated with one or more objects included in the plurality of selection areas 622. For example, in the case that the question is “please point out the food”, the bowl of salad and the bowl of rice may both be considered a correct answer.

In the case where it is determined by the execution module 74 that the user made the correct answer (i.e., when it is determined that the input signal indicates a selected one of the plurality of selection areas 622 that is associated with a corresponding one of the predetermined answers 63 to the question), the execution module 74 controls the text generation module 72 to generate the affirmative response in text form (e.g., “you are correct”), which may be then transformed into speech by the speech synthesizing module 73 and outputted by the audio output unit 3 as the audio signal. Otherwise, in the case that the user did not make the correct answer, the execution module 74 controls the text generation module 72 to generate a guiding response in text form (e.g., “that is not a lamp, please try again”), which may be then transformed into speech by the speech synthesizing module 73 and outputted by the audio output unit 3 as the audio signal.

In some embodiments, the execution module 74 may further instruct the user to speak the name of the object. Specifically, the affirmative response may be in the form of “You are correct, now please say “lamp” with me”. As such, the system may receive a speech input from the user. In response to receipt of the speech input, the execution module 74 determines whether the speech input corresponds with the affirmative response (i.e., whether the user correctly pronounced “lamp”). In the case that the speech input corresponds with the affirmative response, the execution module 74 may control the text generation module 72 to generate a further affirmative response in text form (e.g., “your pronunciation is very good”), which may be then transformed into speech by the speech synthesizing module 73 and outputted by the audio output unit 3 as the audio signal. It is noted that this configuration is an implementation of the “expansion” technique of speech therapies. On the other hand, in the case that the speech input does not correspond with the affirmative response, the execution module 74 may control the text generation module 72 to generate a guiding response in text form (e.g., “you can improve your pronunciation, please listen to my pronunciation and repeat the word “lamp” again”), which may be then transformed into speech by the speech synthesizing module 73 and outputted by the audio output unit 3 as the audio signal. Based on the answer from the user, the above process may be repeated until the correct answer is received. It is noted that this configuration of outputting the guiding response is an implementation of the various speech therapies (e.g., demonstration, extension, expansion, positive reinforcement, etc.).

In the graphic card mode as shown in FIG. 3, the content of the graphic card module 65 is used for generating the second learning screen 62B. On the second learning screen 62B, the question area 621 includes the text “What does the girl want to eat?” which serves as the question, and the question image area 624 shows a girl. The plurality of selection areas 622 show different objects for selection. The three graphic card objects 625 illustrate the words “The girl” “wants to” and “eat”, and the corresponding images, respectively. In use, the user may be instructed to perform a drag-and-drop operation (using a mouse, a stylus or a finger) to drag one of the graphic card objects 625 and drop the same onto the answering area 626, so as to complete a sentence logically.

It is noted that the predetermined answer 63 corresponding to the question may be associated with one or more objects included in the plurality of selection areas 622. For example, in the case that the question is “What does the girl want to eat?,” one of the plurality of selection areas 622 showing cookies may be considered a correct answer.

In the case that the user made the correct answer (i.e., when it is determined that the input signal indicates one of the plurality of selection areas 622 that is associated with the predetermined answer 63 corresponding to the question being dragged and dropped onto the answering area 626), the execution module 74 controls the text generation module 72 to generate the affirmative response in text form (e.g., “you are correct”), which may be then transformed into speech by the speech synthesizing module 73 and outputted by the audio output unit 3 as the audio signal. Otherwise, in the case that the user did not make the correct answer, the execution module 74 controls the text generation module 72 to generate a guiding response in text form (e.g., “You cannot eat a car, try to think what the girl may want to eat?”), which may be then transformed into speech by the speech synthesizing module 73 and outputted by the audio output unit 3 as the audio signal.

In some embodiments, the execution module 74 may further instruct the user to speak the selected object (i.e., an object included in the selection area 622 thus dragged into the answering area 626) and/or the completed sentence. Specifically, the affirmative response may be in the form of “Please tell me your answer” or “You are correct, now please say “The girl wants to eat cookies” with me”. As such, the system may receive a speech input from the user. In response to receipt of the speech input, the execution module 74 determines whether the speech input corresponds with the affirmative response (i.e., whether the user correctly said the selected object or the completed sentence). In the case that the speech input corresponds with the affirmative response, the execution module 74 may control the text generation module 72 to generate a further affirmative response in text form (e.g., “your pronunciation is very good”), which may be then transformed into speech by the speech synthesizing module 73 and outputted by the audio output unit 3 as the audio signal. It is noted that this configuration is an implementation of the “expansion” technique of speech therapies.

On the other hand, in the case that the speech input does not correspond with the affirmative response (for example, when the user says “Pikachu”), the execution module 74 may control the text generation module 72 to generate a guiding response in text form (e.g., Pikachu is a cute electric-type Pokémon, but you cannot eat it. Let's try to say “The girl wants to eat cookies”), which may be then transformed into speech by the speech synthesizing module 73 and outputted by the audio output unit 3 as the audio signal. Based on the answer from the user, the above process may be repeated until the correct answer is received. It is noted that the guiding response outputted in this configuration may reference the response from various speech therapies (e.g., demonstration, extension, expansion, positive reinforcement, etc.).

In the picture book mode as shown in FIG. 4, the content of the picture book module 66 is used for generating the third learning screen 62C. Specifically, the story data file 661 may include a plurality of story files and a plurality of backgrounds that correspond with the plurality of story files, respectively. Each of the story files corresponds with one story and may include a text file and/or an audio file. In use, one of the plurality of story files may be selected, and the corresponding background is used as the question image area 624.

Then, the execution module 74 controls the audio output unit 3 to output the content of the one of the story files, and controls the display unit 4 to display the question in the question area 621. In the example of FIG. 4, the question may be “Who is the mother squirrel taking the little squirrel to see?”, and the one of the predetermined answers 63 is included in the story (e.g., the story may state that the mother squirrel is taking the little squirrel to see a sika deer). After listening to the story, the user is instructed to select the correct answer to the question by, for example tapping one of the selection areas 622 and swiping up.

In the case that the user made the correct answer (i.e., when it is determined that the input signal indicates one of the plurality of selection areas 622 that is associated with the one of the predetermined answer 63 is tapped and swipe up), the execution module 74 controls the text generation module 72 to generate the affirmative response in text form (e.g., “your answer is correct”), which may be then transformed into speech by the speech synthesizing module 73 and outputted by the audio output unit 3 as the audio signal. Otherwise, in the case that the user did not make the correct answer, the execution module 74 controls the text generation module 72 to generate a guiding response in text form, which may be then transformed into speech by the speech synthesizing module 73 and outputted by the audio output unit 3 as the audio signal.

In some embodiments, the execution module 74 may instruct the user to speak an object in the question as the answer. Specifically, an instruction may be read to the user: “Please tell me who the mother squirrel and the little squirrel see?” As such, the system may receive a speech input from the user. In some embodiments, the user may operate the input unit 5 to select one of the plurality of buttons 623 to initiate a “speaking mode” for answering, and in response, the execution module 74 may activate the microphone 2 for receiving the speech input. In response to receipt of the speech input, the execution module 74 determines whether the speech input corresponds with the affirmative response (i.e., whether the user correctly said the object). It is noted that in the case that no speech input is received from the microphone 2 after a predetermined time period (e.g., 3 seconds), the question may be repeated with additional dialog (e.g., do you need a hint to answer the question?).

In the case that the speech input corresponds with the affirmative response, the execution module 74 may control the text generation module 72 to generate an affirmative response in text form (e.g., “you are correct”), which may be then transformed into speech by the speech synthesizing module 73 and outputted by the audio output unit 3 as the audio signal.

In some embodiments, the affirmative response may include additional follow-up questions. For example, after the user selects the correct answer, the execution module 74 may control the text generation module 72 to generate an affirmative response to instruct the user to speak a complete sentence (e.g., you are correct, now please use a sentence to answer the question). In such a case, the one of the predetermined answers 63 may be the sentence “The mother squirrel takes the little squirrel to see the sika deer”. As such, the system may receive a speech input from the user. In response to receipt of the speech input, the execution module 74 determines whether the speech input corresponds with the affirmative response (i.e., whether the user speaks a sentence similar to “The mother squirrel takes the little squirrel to see the sika deer”).

Based on possible different answers that may be provided by the user, different guiding responses may be employed. For example, in the case that the speech input simply includes the term “sika deer” (indicating a partially correct answer), the guiding response may be “Yes, the little squirrel went to see the sika deer. Now please repeat the sentence.” In the case that the speech input includes the sentence “The little squirrel went to see the sika deer” (indicating a partially correct answer), the guiding response may be “Yes, the mother squirrel is taking the little squirrel to see the sika deer. Now please repeat the sentence.” In the case that the speech input includes the sentence “the little squirrel is taking the mother squirrel to see the sika deer” (which, because the order of the words have been changed which changes the meaning of the sentence, is deemed an incorrect answer), the guiding response may be “No, the mother squirrel is taking the little squirrel to see the sika deer. Now please repeat the sentence.” The above process may be repeated until the correct answer is received. It is noted that this configuration is an implementation of the “expansion” technique of speech therapies.

On the other hand, in the case that the speech input does not correspond with the one of the predetermined answers 63 (for example, when the user says “rabbit”), the execution module 74 may control the text generation module 72 to generate a guiding response in text form, which may be then transformed into speech by the speech synthesizing module 73 and outputted by the audio output unit 3 as the audio signal. Based on the answer from the user, the above process may be repeated until the correct answer is received. It is noted that the guiding response outputted in this configuration may reference the response from various speech therapies (e.g., demonstration, extension, expansion, positive reinforcement, etc.).

In the dialog mode as shown in FIG. 5, the content of the dialog module 67 is used for generating the fourth learning screen 62D. FIG. 5 illustrates an exemplary fourth learning screen 62D associated with the dialog mode. In use, after the user selects the dialog mode, the controller 7 may access the dialog module 67 to generate the fourth learning screen 62D, and to control the display unit 4 to display the fourth learning screen 62D. The fourth learning screen 62D may have a background taken from the content of the map data file 671 (e.g., a partial image extracted from a map 672 included in the map data file 671, indicating a geographical area), and includes the plurality of buttons 623, a player character area 627 that displays a player character associated with the user, and a non-player character (NPC) area 628 that displays an NPC that may interact with the player character. The plurality of buttons 623 may further include a number of directional buttons for enabling the user to control movement of the player character as indicated by the player character area 627. In the case that the player character area 627 is moved within a predetermined distance from the NPC area 628, the question area 621 including the object portion 683 for displaying an object and a text portion 684 may pop up. In the example of FIG. 5, the object portion 683 may illustrate a cane, and the text portion 684 may include the text “The elderly man has lost his cane”.

In use, the user may be instructed to press one of the plurality of buttons 623 to initiate the speaking function, speak a sentence in response to the situation as indicated by the question area 621 through the microphone 2, and the execution module 74 may determine whether the sentence fits the situation. For example, a sentence such as “Hi, can I help you find your cane?” may be deemed as correct, and an affirmative response may be generated and outputted to the user. In the cases the sentence spoken by the user does not fit the situation, a guiding response (e.g., “This elderly man has lost his cane. How can we help him?”) may be generated and outputted to the user.

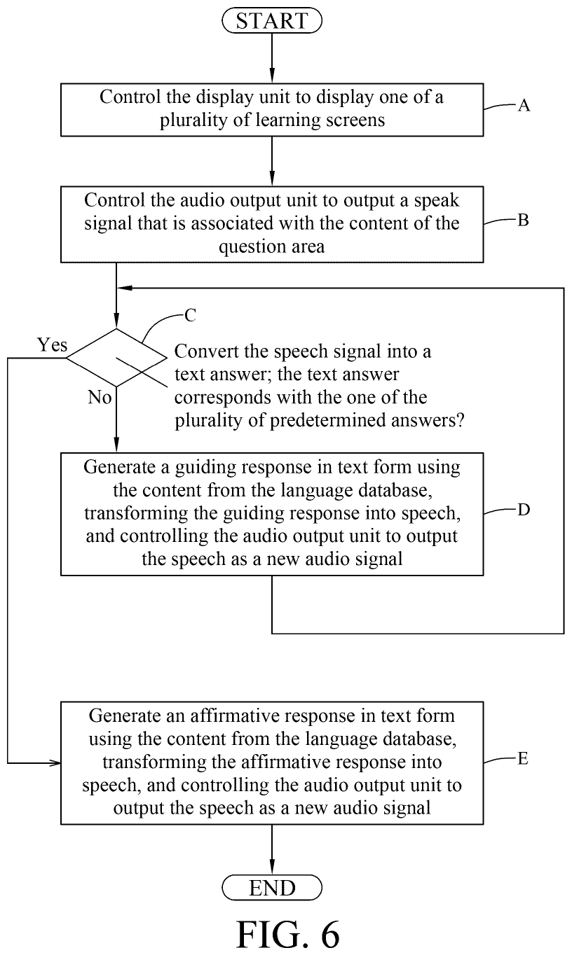

FIG. 6 is a flow chart illustrating steps of a method for implementing interactive language learning according to one embodiment of the disclosure. In the embodiment of FIG. 6, the method is implemented using the system as shown in FIG. 1.

In step A), in response to a user input for executing the interactive language learning software, the controller 7 controls the display unit 4 to display one of a plurality of learning screens 62. It is noted that the one of the plurality of learning screens 62 may be generated from any one of the echolalia module 64, the graphic card module 65, the picture book module 66 and the dialog module 67.

Then, in step B), the controller 7 controls the audio output unit 3 to output a speak signal that is associated with the content of the question area 621 included in the one of the plurality of learning screens 62. The speak signal serves as an instruction for the user to input a speech input to the microphone 2. In response to receipt of the speech signal from the microphone 2, the controller 7 determines whether the speech signal corresponds with the one of the plurality of predetermined answers 63 by converting the speech signal into a text answer and comparing the text answer to the one of the plurality of predetermined answers 63. That is to say, in step C), the controller 7 determines whether the text answer corresponds with the one of the plurality of predetermined answers 63.

In some embodiments, the controller 7 determines that the text answer does not correspond with the one of the plurality of predetermined answers 63 in a case that a number of words included in the text answer is different from a number of words included in the one of the plurality of predetermined answers 63, that at least one word included in the text answer has a meaning different from that of a corresponding one of words included in the one of the plurality of predetermined answers 63, or that an order of the words of the text answer is different from that of words included in the one of the plurality of predetermined answers 63.

In some embodiments, the controller 7 determines that the text answer partially corresponds with the one of the plurality of predetermined answers 63 in cases that at least one word included in the text answer has a meaning similar to that of a corresponding one of words included in the one of the plurality of predetermined answers 63, that no word included in the text answer has a meaning different from that of the corresponding words included in the one of the plurality of predetermined answers 63, and that an order of the words of the text answer is identical to that of words included in the one of the plurality of predetermined answers 63. In the case that the controller 7 determines that the speech signal does not correspond with the one of the plurality of predetermined answers 63, the flow proceeds to step D). Otherwise, the flow proceeds to step E).

In step D), in the case where the controller 7 determines that the text answer does not correspond with the one of the plurality of predetermined answers 63, the text generation module 72 of the controller 7 generates a guiding response in text form using the content from the language database 61. The guiding response is then transformed into speech by the speech synthesizing module 73, and outputted by the audio output unit 3 as a new audio signal. Then, the flow goes back to step C) to receive another speech input.

In step E), in the case where that the controller 7 determines that the text answer corresponds with the one of plurality of the predetermined answers 63, the text generation module 72 of the controller 7 generates an affirmative response in text form using the content from the language database 61. The guiding response is then transformed into speech by the speech synthesizing module 73, and outputted by the audio output unit 3 as a new audio signal. The method is then terminated.

In some embodiments, step E) may include generating the affirmative response to include a further question. Then, the flow goes back to step C) to receive another speech input.

According to some embodiments, the language database 61 includes a safeguard dataset 611 and an alignment dataset 612. The safeguard dataset 611 may include a plurality of inappropriate words and strings that are considered inappropriate (e.g., offensive, misleading, immoral, etc.), and a plurality of predetermined rules and content filters associated with content that is considered to be inappropriate for display by the display unit 4. The alignment dataset 612 may include a number of predetermined words and strings that are typically used for providing various speech therapies (e.g., echolalia, demonstration, expansion, positive reinforcement, etc.), and may include content such as dialog for speech therapies, questions and answers for interacting with patients, words for providing positive reinforcement with a soft tone, etc.

According to some embodiments, step D) includes, for the question area 621, generating, by the text generation module 72, the guiding response to not include the one of the plurality of predetermined answers 63. In this configuration, the guiding response is aimed to encourage the user to formulate the answer for himself/herself rather being directly provided with the answer.

According to some embodiments, step D) includes, for the question area 621, determining whether an incorrect answer has been received and whether a guiding response has been outputted before. In the case that the determination is affirmative, it may indicate that the user was given the guiding response but is still unable to provide the correct answer. As such, the guiding response may be generated by the text generation module 72 to include some content in the one of the plurality of predetermined answers 63. In this configuration, the guiding response is aimed to provide a hint for the user formulate the answer for himself/herself rather than being directly provided with the answer.

According to some embodiments, step D) includes, for the question area 621, determining whether an incorrect answer has been received and whether a guiding response that includes some of the content in the one of the plurality of predetermined answers 63 has been outputted before. In the case that the determination is affirmative, it may indicate that the user was given a stronger hint but is still unable to provide the correct answer. As such, the guiding response may be generated by the text generation module 72 to include the entirety of the one of the plurality of predetermined answers 63. In this configuration, the guiding response is aimed to directly provide the answer so that the user may practice repeating the answer.

According to some embodiments, step D) includes, for the question area 621, in the case that it is determined the speech input partially corresponds with the one of the plurality of predetermined answers 63, generating, by the text generation module 72, the guiding response to include at least a part of the one of the plurality of predetermined answers 63 that is not included in the text answer. In this configuration, the guiding response is aimed to provide more information to the user as a guidance (i.e., the “expansion” technique) in the case that the answer provided by the user is already partially correct without any material mistakes.

To sum up, embodiments of the disclosure provide a system and a method for implementing interactive language learning. The system and the method include a number of advantages as described below.

Firstly, by providing the language database 61, the controller 7 including the speech recognition module 71, the text generation module 72 and the speech synthesizing module 73, a question may be outputted in the form of speech for a user using the system, and a speech input from the user can be converted into the form of text, therefore enabling the controller 7 to determine whether an answer given by the user is correct, incorrect or partially correct. As such, different responses based on the speech input may be generated and outputted by the system. In this manner, the system may be considered to be capable of implementing interactive language learning for the user, including the operations of language learning practicing which is typically done with a patient and family member. That is to say, by utilizing the system, the need of a family member to continuously be present for the language learning practicing may be reduced.

Also, the language database 61 may include the safeguard dataset 611 and the alignment dataset 612 to generate the responses that are appropriate and that more closely resemble the responses that may be given from actual professional language therapists, and therefore may result in improved efficiency for the user in interactive language learning.

Additionally, the text generation module 72 may be configured to provide different guidance responses based on different scenarios. For example, in the case that the user gives an incorrect answer the first time, the text generation module 72 may generate the guiding response to not include the one of the plurality of predetermined answers 63. In this configuration, the guiding response is aimed to encourage the user to think of the answer for himself/herself rather than being directly provided with the answer. As such, the system may prompt the user to formulate the correct answer in the occasion that the user did not answer with the correct answer.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A system for implementing interactive language learning, comprising:
a microphone that is for receiving a speech input from a user, and that outputs a speech signal;
an audio output unit that is for receiving an audio signal and outputting the same;
a data storage unit that stores a language database, a plurality of learning screens, and a plurality of predetermined answers, each of the plurality of learning screens including a question area that displays a question that is associated with one of the plurality of predetermined answers;
a display unit that is for, in response to receipt of a display signal, displaying one of the plurality of learning screens; and
a controller connected to the microphone, the audio output unit, the data storage unit and the display unit, the controller including a speech recognition module, a text generation module and a speech synthesizing module, wherein
the speech synthesizing module is programmed to process the question to generate the audio signal related to the question;
the speech recognition module is programmed to process the speech signal for recognizing a speech, and to output a text answer based on the speech signal;
the controller is programmed to determine whether the text answer corresponds with one of the plurality of predetermined answers associated with the question, generate one of an affirmative response and a guidance response based on a result of the determination, control the speech synthesizing module to transform the one of the affirmative response and the guidance response into a form of speech, and controls the audio output unit to output the one of the affirmative response and the guidance response as a new audio signal.

2. The system as claimed in claim 1, further comprising an input unit connected to the controller for receiving an input signal associated with a location of the display unit, wherein:
the one of the plurality of learning screens includes a plurality of selection areas, the input signal indicating a selected one of the plurality of selection areas, and the one of the plurality of predetermined answers indicates a predetermined one of the plurality of selection areas;
the controller further includes an execution module that is programmed to determine, based on the input signal, whether the selected one of the plurality of selection areas is the predetermined one of the plurality of selection areas, and generates the one of the affirmative response and the guidance response based on a result of the determination.

3. The system as claimed in claim 2, wherein:
the controller is operable in a graphic card mode in which the one of the plurality of learning screens includes the question area, the plurality of selection areas and an answering area, and the one of the plurality of predetermined answers is associated with one of the plurality of selection areas;
the input signal is in the form of a drag-and-drop operation of dragging one of the selection areas and dropping the same onto the answering area;
the execution module is programmed to determine, based on the input signal, whether the one of the selection areas dropped onto the answering area is associated with the one of the plurality of predetermined answers, and generates the one of the affirmative response and the guidance response based on a result of the determination.

4. The system as claimed in claim 1, further comprising an input unit connected to the controller for receiving an input signal associated with a location of the display unit, wherein:
the controller is operable in a picture book mode in which the one of the plurality of learning screens includes the question area, the plurality of selection areas and a plurality of buttons;
in response to receipt of the input signal which is associated with the user operating the input unit to select one of the plurality of buttons to initiate a speaking mode, the controller activates the microphone for receiving the speech input.

5. The system as claimed in claim 1, wherein language database includes a safeguard dataset and an alignment dataset.

6. A method for implementing interactive language learning, the method being implemented using a system as claimed in claim 1 and comprising:
A) controlling, by the controller, the display unit to display one of the plurality of learning screens;
B) controlling, by the controller, the audio output unit to output a speak signal that is associated with the content of the question area included in the one of the plurality of learning screens, and receiving, by the microphone, the speech signal;
C) converting, by the controller, the speech signal into a text answer and comparing the text answer to the one of the plurality of predetermined answers so as to determine whether the text answer corresponds with the one of the plurality of predetermined answers; and
D) in the case that the determination of step C) is negative, generating a guidance response, controlling the speech synthesizing module to transform the guidance response into a form of speech, and controls the audio output unit to output the guidance response as a new audio signal.

7. The method as claimed in claim 6, wherein step C) includes:
for the question area, determining whether an incorrect answer has been received and whether a guiding response has been outputted before; and
in the case that the determination is affirmative, generating the guiding response to include some content in the one of the plurality of predetermined answers.

8. The method as claimed in claim 6, wherein step C) includes:
for the question area, determining whether an incorrect answer has been received and whether a guiding response that includes some content in the one of the plurality of predetermined answers has been outputted before; and
in the case that the determination is affirmative, generating the guiding response to include the entirety of the one of the plurality of predetermined answers.

9. The method as claimed in claim 6, wherein step C) includes:
for the question area, in the case that it is determined the speech input partially corresponds with the one of the plurality of predetermined answers, generating the guiding response to include at least a part of the one of the plurality of predetermined answers that is not included in the text answer;
wherein the controller determines the text answer partially corresponds with the one of the plurality of predetermined answers in the cases that:
at least one word included in the text answer has a meaning similar to that of a corresponding one of words included in the one of the plurality of predetermined answers;
no word included in the text answer has a meaning different from that of the corresponding words included in the one of the plurality of predetermined answers; and
an order of the words of the text answer is identical to that of words included in the one of the plurality of predetermined answers.

10. The method as claimed in claim 6, wherein step C) includes determining the text answer does not correspond with the one of the plurality of predetermined answers in one of the cases that:
a number of words included in the text answer is different from a number of words included in the one of the plurality of predetermined answers;
at least one word included in the text answer has a meaning different from that of a corresponding one of words included in the one of the plurality of predetermined answers; or
an order of the words of the text answer is different from that of words included in the one of the plurality of predetermined answers.
